(19) United States
(12) Patent Application Publication
(10) Pub. No.: US 2008/0083312 A1
(43) Pub. Date: Apr. 10, 2008

(54) KNIFE SHAFT ASSEMBLY AND METHOD

(76) Inventor: Robert A. Zschoche, Warrenton, OR (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(21) Appl. No.: 11/867,613

(22) Filed: Oct. 4, 2007

Related U.S. Application Data
(60) Provisional application No. 60/828,361, filed on Oct. 5, 2006.

(51) Int. Cl. B23P 19/04; B23D 19/00; B23D 19/04

(52) U.S. Cl. 83/469; 29/700; 83/481

(57) ABSTRACT

Embodiments of the present invention provide a cutting apparatus and a method having a shaft with a first end and a second end. Multiple blades are fitted onto the shaft. A first side support supports the shaft at the first end and is sufficiently strong to support the shaft and the multiple blades without there being support for the second end. The exposed second end facilitates removal of the blades from the shaft by sliding the blades along the shaft and off the second end. A holding shaft may be coupled to the second end of the shaft on the cutting apparatus, and the multiple blades can be slide off the shaft and onto the holding shaft.

### CROSS-REFERENCE TO RELATED APPLICATIONS

The present application claims priority to U.S. Patent Application No. 60/828,361, filed Oct. 5, 2006, entitled “KNIFE SHAFT ASSEMBLY STABILIZING SYSTEM,” the entire disclosure of which is hereby incorporated by reference in its entirety.

### TECHNICAL FIELD

Embodiments of the invention pertain to food product slicing machines, and in particular to an improved knife shaft assembly adapted to keep the assembly relatively stable during the slicing process and/or during a blade change out process from one side of the shaft.

### BACKGROUND

Food processing applications, e.g., meat and vegetable slicing machines, often require the use of wide belt slicing systems. Wide belt slicing systems can have processing portions that reach widths well over 1 meter. Such systems struggle, however, with how to retain the straightness of the knife shaft, and thus the blades, while also allowing for ease of maintenance and sanitation.

When a series of blades are placed across a wider knife shaft, the shaft may have the occasion to flex or bend in production if the assembly encounters a difficult to slice and/or inconsistent product. As a result of this shaft flexing, the attached blades are lifted out of any guide block in which they are housed. This can defeat the purpose of maintaining the position of the blades within the guide blocks such that they do not bend in operation. Such bending may cause blade damage as well as inconsistent slice width.

In trying to accomplish a stable process knife shaft assembly, current slicing systems that process over wider conveyors generally include a significant superstructure on both sides of the conveyor to provide stability. The inclusion of such superstructure, however, requires the entire shaft assembly to be removed from the superstructure in order to complete the disassembly of the components (e.g. remove blades, spacers and devices adapted to remove product from blades such as kick-out fingers) in order to clean and sanitize the system. This is not only time-consuming, but is also inefficient. The other option is to reduce the weight of the assembled knife shaft with blades spacers and kick-out fingers, which generally requires reducing the width of the knife shaft. Such reduction in width tends to increase the potential for shaft flex during processing of difficult to slice products, which can lead to unacceptable finished product.

### BRIEF DESCRIPTION OF THE DRAWINGS

Embodiments of the present invention will be readily understood by the following detailed description in conjunction with the accompanying drawings. Embodiments of the invention are illustrated by way of example and not by way of limitation in the figures of the accompanying drawings.

FIG. 1 is a perspective view of various elements of an example slicing machine in accordance with various embodiments of the present invention;

FIG. 2A is perspective view and FIG. 2B is a detailed exploded view illustrating various embodiments of a knife shaft assembly in accordance with the invention;

FIG. 3 is a perspective view of various embodiments of a knife shaft assembly but with many features in common with the embodiment illustrated in FIGS. 1A, 1B and 2, but also with some elements removed for illustration;

FIG. 4 is a perspective view of the embodiment illustrated in FIG. 2 showing a second end of a shaft unsupported;

FIG. 5A is a partial view of a knife shaft assembly in accordance with various embodiments;

FIG. 5B is an exploded view of portions of the knife shaft assembly of FIG. 5A in accordance with various embodiments;

FIG. 6 illustrates a perspective view of a cleaning cart 200 in accordance with various embodiments of the invention;

FIG. 7 illustrates a flow diagram illustrating a method in accordance with various embodiments of the invention; and

FIG. 8 illustrates a flow diagram illustrating a method in accordance with various embodiments of the invention.

### DETAILED DESCRIPTION OF EMBODIMENTS OF THE INVENTION

In the following detailed description, reference is made to the accompanying drawings which form a part hereof wherein like numerals designate like parts throughout, and in which is shown by way of illustration embodiments in which the invention may be practiced. It is to be understood that other embodiments may be utilized and structural or logical changes may be made without departing from the scope of the present invention. Therefore, the following detailed description is not to be taken in a limiting sense, and the scope of embodiments in accordance with the present invention is defined by the appended claims and their equivalents.

Various operations may be described as multiple discrete operations in turn, in a manner that may be helpful in understanding embodiments of the present invention; however, the order of description should not be construed to imply that these operations are order dependent.

The description may use perspective-based descriptions such as up/down, back/front, and top/bottom. Such descriptions are merely used to facilitate the discussion and are not intended to restrict the application of embodiments of the present invention.

For the purposes of the present invention, the phrase “A/B” means A or B. For the purposes of the present invention, the phrase “A and/or B” means “(A), (B), or (A and B).” For the purposes of the present invention, the phrase “at least one of A, B, and C” means “(A), (B), (C), (A and B), (A and C), (B and C), or (A, B and C).” For the purposes of the present invention, the phrase “(A)B” means “(B) or (AB),” that is, A is an optional element.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

The description may use the phrases “in an embodiment,” or “in embodiments,” which may each refer to one or more of the same or different embodiments. Furthermore, the terms “comprising,” “including,” “having,” and the like, as used with respect to embodiments of the present invention, are synonymous.

Embodiments of the present invention include a knife shaft assembly that may be both easily accessible for disassembly and maintenance, and yet provide a general resistance to unacceptable flexing during a slicing operation.

In one embodiment, a knife shaft may extend from a plate upon which blades, spacers and kick-out fingers may be placed to achieve the proper slice widths. The shaft may be of a sufficient strength to hold the assembled blades, spacers and kick-out fingers in place during a disassembly process. The shaft may also be light enough in weight that such suspension or cantilevering of the assembly can be achieved without overly stressing and/or damaging the shaft or frame necessary to couple the assembly in a processing configuration absent significant outboard support. One example of such a shaft would be a shaft made of a stainless steel or other material suitable for food processing applications. In various embodiments, the shaft may be solid, which may improve the rigidity at a reduced diameter. In other embodiments, the shaft may be hollow. In one embodiment, the diameter of the shaft may be less than three inches.

In various embodiments, a releasable side-plate may be located on one side of the conveyor and coupled to the shaft to help stabilize the shaft assembly during production. This plate may be removable in order to facilitate easier and more efficient cleaning operations. Release and/or removal of the releasable side plate may generally allow relatively unrestricted access to the blades, spacers, and kick-out fingers to help allow for removal and cleaning.

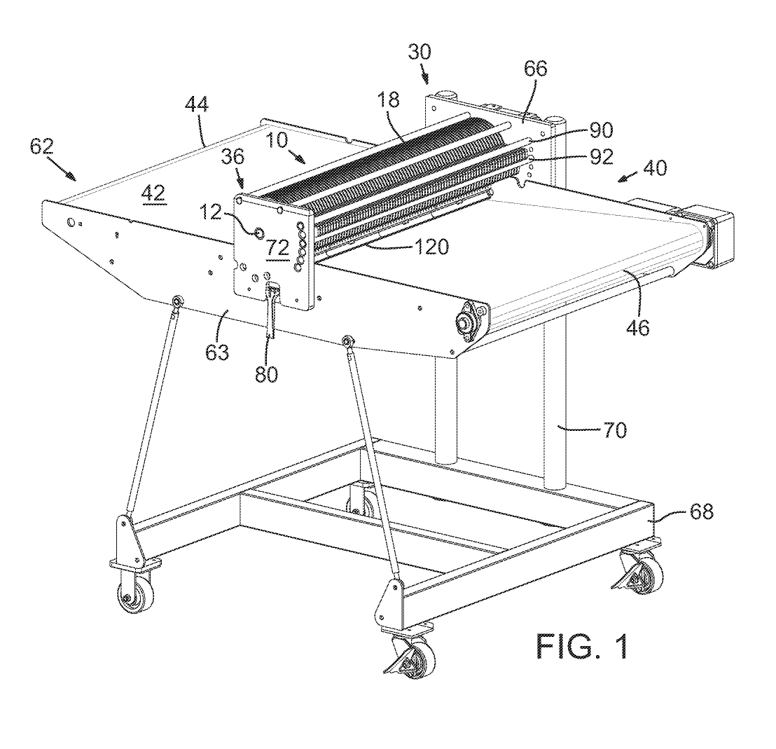

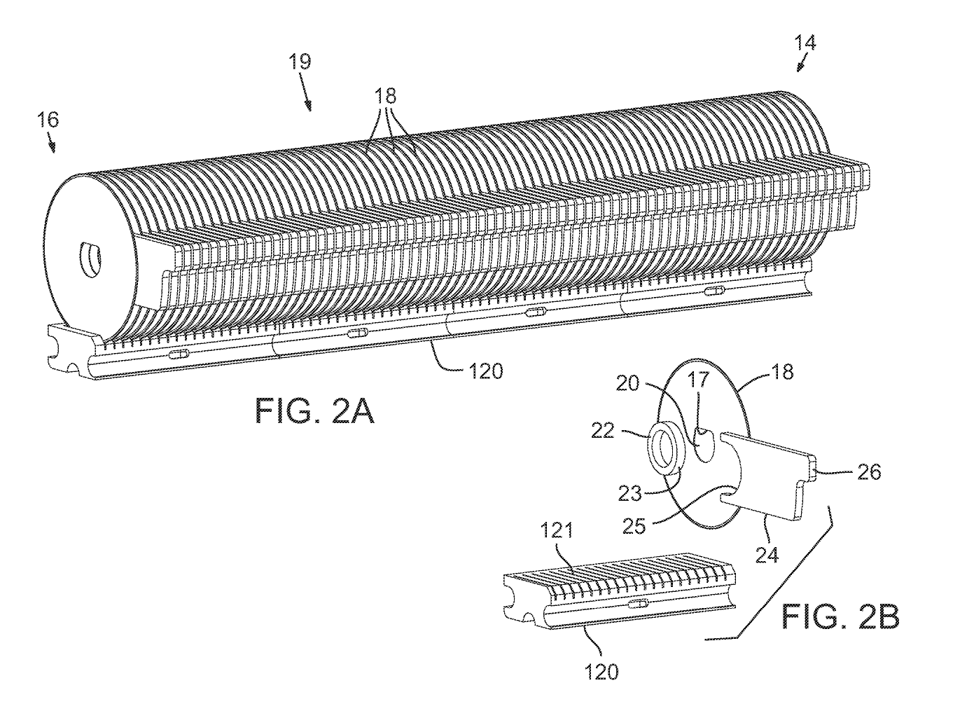

FIG. 1 is a perspective view of a slicing machine in accordance with various embodiments. FIG. 2A is perspective view and FIG. 2B is a detailed exploded view of a cutting assembly illustrating various embodiments. A cutting assembly 10 may include a shaft 12 having a first end 14, and a second end 16. Multiple blades 18 may be operatively disposed on the shaft for rotation. Each blade 18 may have a hole 20 there through for being fitted onto the shaft 12. The shaft 12 and the blades 18 may have mating keyed, or notched, profiles 13 and 17 to ensure the blades rotate with the shaft 12.

Multiple spacers 22 may also be fitted onto the shaft 12, and may be interposed between each of the respective multiple blades 18 and adapted to rotate relative to the shaft. The multiple blades 18 and the multiple spacers 22 may be referred to as a blade set 19. Multiple kick out fingers 24 may also be interposed between respective blades 18. In various embodiments, each kick-out finger 24 may have a first end with a profile 25 substantially similar to an annular outside surface 23 of each of the spacers 22, and may be adapted to fit adjacent to the spacers 22. Each kick-out finger 24 may also have a protrusion 26 on a second end opposite the first end and adapted to engage, for example, a cross spanning member to help prevent rotation.

The cutting assembly 10 may be disposed on a cutting machine 40, and supported at a first end/side 30 and a second end/side 36. The cutting machine 40 may have an endless belt 42 for conveying a material to be cut (not shown) from an input end 44 through the blades 18 for slicing, and for conveying the sliced product (not shown) to an output end 46. In various embodiments, the belt 42 may be a single endless belt, or may be two or more separate belts disposed on each side of the cutting assembly. The belt may be made of a variety of materials, including but not limited to food grade plastics, rubber, and/or metal.

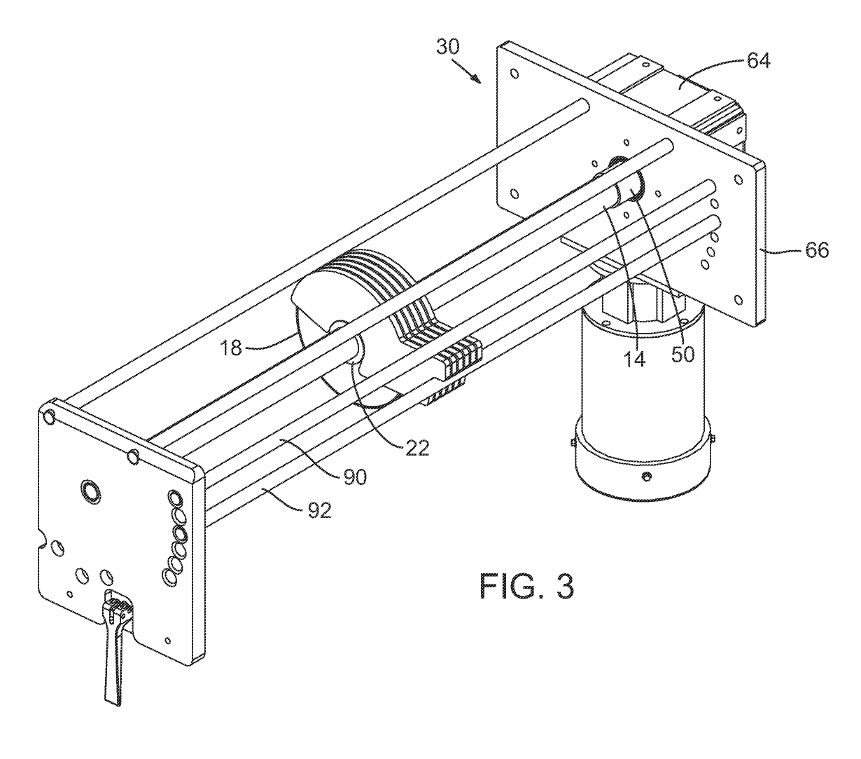

FIG. 3 is a perspective view of various other embodiments but with many features in common with the embodiment illustrated in FIGS. 1, 2A, and 2B, but also with some elements removed for illustration. A first end support 66 may be disposed on the first end 30 and configure to support the shaft 12 at the shaft first end 14. A driver 64, for example a motor, may be disposed at the first side 30 and may be operatively coupled with the first end 14 of the shaft 12 to rotate the shaft as the material passes through the blades 18 for cutting. In various embodiments, first end support 66 may be disposed on first side 30 of the cutting machine 40 and may be coupled to a frame 68 of the cutting machine 40 via upright members 70.

The driver 64 may be disposed on an outer side of the first end support 66. The driver may also be coupled with a first end support 66 and/or coupled with the shaft 12 through the first end support 66. A holding element 50 may be formed as a sleeve coupled to an inside of the first side plate 66 and adapted to engage the first end 14 of shaft 12. The shaft 12 may pass through the holding element 50 to couple with the driver 64. In various embodiments, the first end support 66 may be sufficiently strong to support the entire weight of the cutting assembly 10 without there being support for the second end 16. As illustrated in FIG. 4, the shaft and blades may therefore be cantilevered from the first side 30 of the cutting machine 40 to second side 36, with the second end 16 unsupported. In various embodiments, the driver 64 may serve as a counter-weight, or stabilizing member for the weight of the shaft 12, the spacers 22, and the blades 18, and any other elements that may be supported by or coupled with the shaft 12.

A second side wall 63 (FIGS. 1 and 4) may be disposed on the second side 62 of the cutting machine 40. A second side support 72 may be adapted to be coupled with the second side wall 63, and may be adapted to be released and removed from its coupled engagement with the second side wall 63. In some embodiments the second side support 72 may be adapted to be a quick release support or in other embodiments may be simply removable and referred to as a removable support or removable plate.

In certain embodiments where the second side support 72 is a quick release support, it may be released for removal by manipulating a quick release lever 80. The quick release lever 80 may include a release mechanism that may include, for example, an eccentric, or oblong locking element keyed which may be able to pass through a hole on the second side wall 63 in a first orientation, and unable to pass through the hole in a second orientation. The locking element may be pulled tight against an inner side of the second wall 63 while in the second orientation with, for example, a cam arrangement in contact with an outside of the second side wall 63, and adapted to force the locking element into frictional engagement with an inside of second side wall 63 when the quick release lever 80 is in the locking position.

In various embodiments, one or more cross members (e.g. 90, 92, 94, 96, and 98) (also referred to as bridging members/rods, and spanning members/rods) may be disposed to span from the first side support 66 to the second side support 72. The cross members may be, for example, one or more rods or shafts, and function to support various components and/or add stability to the machine during operation. The first and second side supports 66 and 72 may have holes through which and/or into which the cross members may be disposed in order to couple the cross members therewith. In various embodiments, there may be multiple hole configurations to allow placement of the cross members in desired locations (for example to manipulate the kick out finger stop locations)

In various embodiments, a first cross member 90 may be disposed above the protrusion 26 on the kick-out fingers 24. A second cross member 92 may be disposed below the protrusion 26. The first cross member 90 and the second cross member 92 may serve to contain movement of the kick-out fingers 24 with respect to the adjacent blades 18.

In various embodiments, one or more guide blocks 120 may be disposed under the blades 18 and may have multiple slits 121 to respectively receive and guide the multiple blades 18. The material to be sliced may pass over the guide blocks 120, and the sliced product may drop to the belt 42 to be conveyed to the output end (FIGS. 2 and 4). The guide blocks 120 may be removable from under the blades, and in various embodiments may have a grabbing slot along one face adapted to mate with a pulling member.

A third cross member 94 (FIG. 4) which may also span from the first side 30 to the second side 36, may be disposed at a trailing edge side of the guide blocks 120 to at least partially hold the guide blocks 120 in place. A fourth cross member 96 may also span from the first side 30 to the second side 36, and may be disposed at a leading edge side of the guide blocks 120. A fifth cross member 98 may be disposed under the guide blocks 120.

In various embodiments, the cross members may protrude slightly through second side support 72. The cross members may include a pulling feature such as a hole, or a notch, or the like, disposed at the protruding portion. The pulling feature may be adapted to couple with a pulling tool (not shown) to aid in pulling the rods through the holes in the second end support for removal.

In various embodiments, when being disassembled (e.g. for a cleaning operation), the cross members and the second side support member 72 may be removed (illustrated in FIG. 4). So removed, the cutting assembly 10 may be cantilevered from the first side support 66, and the cutting assembly components (e.g. the blades, spacers, kick-out fingers, and other components such as vertical stabilizer plates (discussed below)) may be accessed and removed for cleaning. Allowing such removal may help resist damage to the knife shaft and other components, such as a power source that may be positioned on the opposite side of the conveyor and the support structure. Further, disassembly and assembly may be handled in more efficient manner, as opposed to using a crane or other lift in mechanism to remove the entire shaft assembly from the cutting machine.

In various embodiments, one or more stabilizer members, such as rods, shafts and/or a plate, may be positioned about the blades and knife shaft and assist in resisting non-rotational movement of the shaft which may be caused by slicing food items that are more difficult to cut. In various embodiments, portions of the stabilizer members may be positioned towards the inner and/or middle portion of the knife shaft assembly to help provide support to the portion of the shaft most susceptible to flexing during a processing operation. In various embodiments, the stabilizer members may be coupled to the shaft in a generally perpendicular fashion and in between the blades. In various embodiments such a coupling may be similar in nature to how the spacers and/or product kick-out fingers are coupled to the shaft. The stabilizer member may then interface with bridging cross members to resist non-rotational shaft movement.

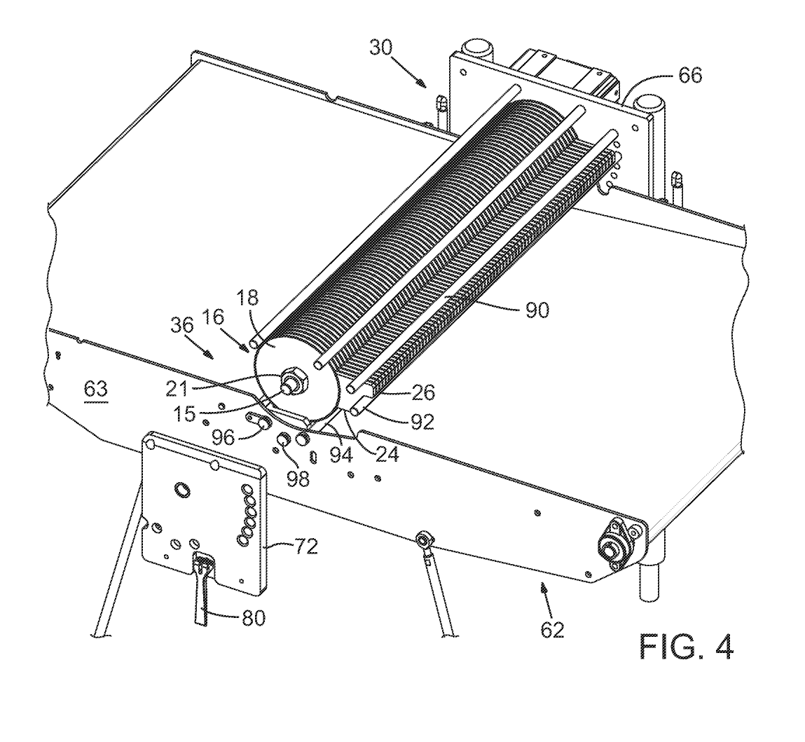

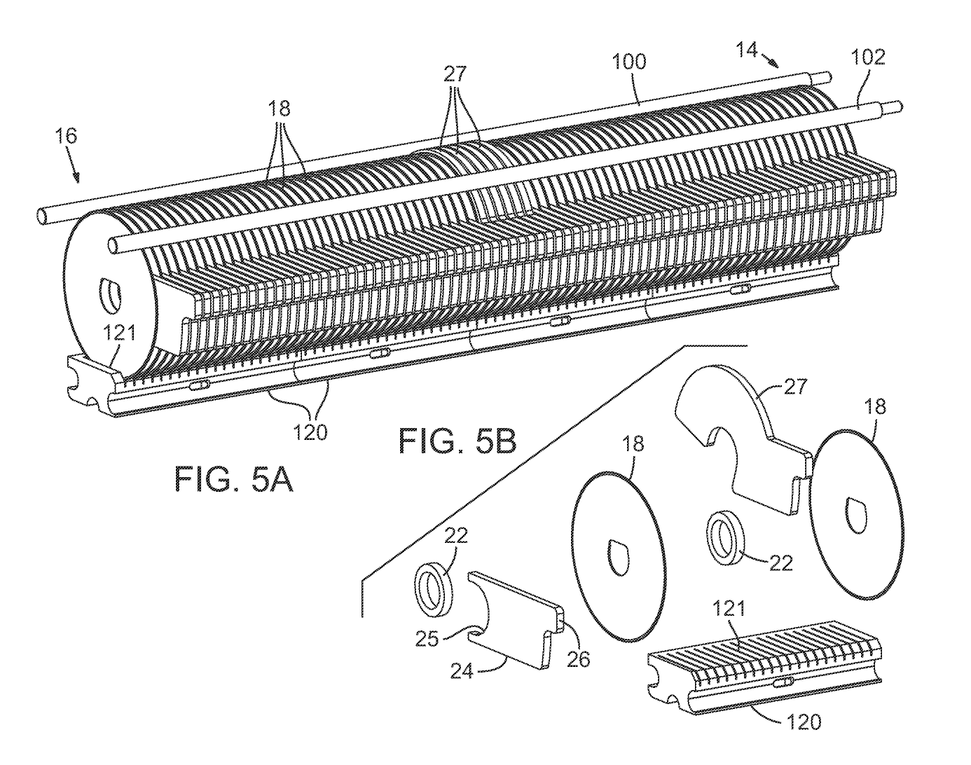

FIG. 5 is a partial exploded view of a cutting assembly in accordance with various embodiments. One or more kick-out fingers 26 may be replaced with stabilizer members 27 (see also FIG. 3), which are configured to have an outer surface that protrudes above the upper edge portion of the blades in the cutting assembly. Attritional cross members may be disposed above the stabilizer members 27 such that they may help restrict non-rotational movement of the shaft. In one embodiment, a sixth cross member 100 may be disposed, above and on the leading edge side of a center of the blades 18. A seventh cross member 102 may be disposed, above and on a trailing edge side of a center of the blades 18. The sixth cross member 100 and seventh 102 cross member may be spaced a desired distance from an annular surface of the blades 18 to resist non-rotational movement as desired. In various embodiments, the stabilizer members may be positioned midway between, for example, the first end 14 and the second end 16 of the shaft 12 where non-rotational movement may tend to be the greatest (see also FIG. 3).

When performing a slicing operation, as the blades engage material to be cut that proves to be more difficult to cut, the stabilizer members 27 may be adapted to receive whatever load or force is created by the difficult to cut material. The stabilizer members 27 may then transfer the load to the sixth and seventh cross members 100 and 102, which in turn may help maintain the position of the shaft 12, and reduce and/or eliminate flex that may have otherwise occurred. The sixth and seventh cross members 100 and 102 may be referred to as a stabilizing rod.

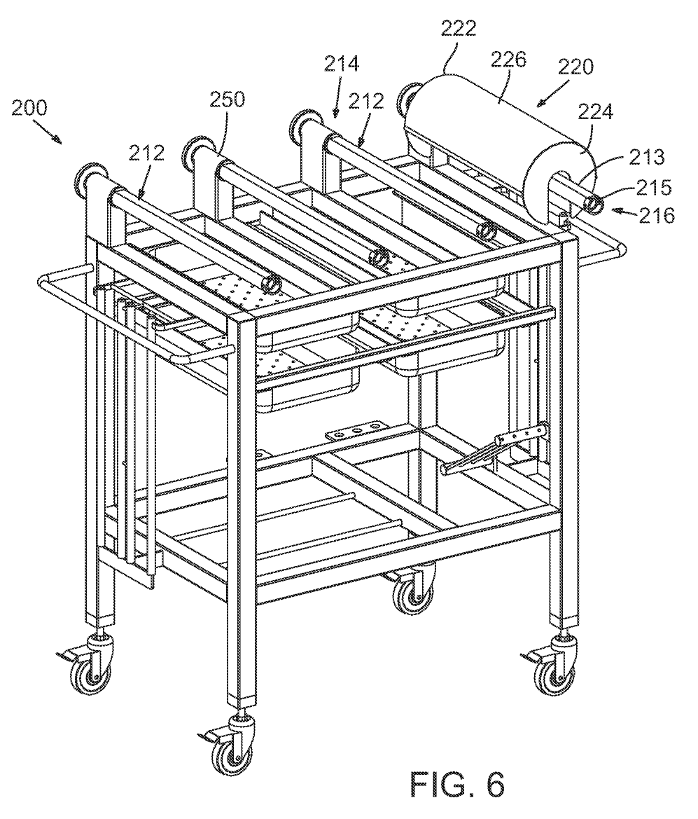

FIG. 6 illustrates a perspective view of a cleaning cart 200 in accordance with various embodiments of the invention. The cleaning cart 200 may include one or more holding shafts 212 having a first end 214, and a second end 216. The holding shaft 212 may be supported on just the first end 214 by a shaft holding member 250 and cantilevered out over the cleaning cart 200. The second end 216 of the holding shaft 212 may be brought up against the second end 16 of the shaft 12 on cutting assembly 10, and the shafts 12 and 212 positioned respectively collinearly. In some embodiments a coupling arrangement may be employed. For example, the shaft 12 may have a reduced diameter portion 15 (FIG. 4), and the shaft 212 may have a hollow portion 215, at least on the second end 216 into which the reduced diameter portion 15 may fit. In other embodiments the respective male and female portions may be on the respective opposite shafts. In various embodiments, either or both shafts may have a coupling arrangement that fixes the mating of the shafts. In one embodiment, the cutting assembly 10 shaft 12 second end 16 and the reduced diameter portion 15 may each include a hole to receive a locking member such as short stud, or lock screw, or the like (not shown) may be adapted to lock the shaft 12 to the holding shaft 212. The coupling arrangement may also serve to properly align the notched profile 13 on the cutting assembly shaft 12 with a similar notched profile 213 on the holding shaft 212.

Once the assembly retaining nut 21 (FIG. 4) is removed and the cutting assembly 10 shaft 12 is coupled with the holding shaft 212 the blades 18 may be slide from shaft 12 to the holding shaft 212. A blade transfer element 220 may be employed as an aid for transferring the blades 18 and spacers 22 to the holding shaft 212. The blade transfer element 220 may include a first end wall 222, and an opposite second end wall 224 coupled by a semi-cylindrical body 226. Each of the first and second end walls 222 and 224 may include a notch 228 being at least as wide as the outer diameter of a spacer 22. The blade transfer element 220 may be placed over all or a portion of the blades 18 and spacers 22 with the first end wall 222 between adjacent blades 18, or at the end of the set of blades with the blade transfer element 220 oriented parallel with the shaft 12. Then the blade transfer element 220 may be pushed or pulled toward the cleaning cart 200 dragging the blades with it. The outside of the first end wall 222 may have pulling handles (not shown) to facilitate the transfer.

The blade transfer element 220 may serve various purposes. For example, without limitation it may serve to do one or more of: extend the reach of user as the user stands on an opposite side of the cleaning cart 200; protect the user's hands, protect the blades; and speed up the transfer process. The user can transfer any number of blades 18 and spacers 22 at a time according to where the second end wall 224 in placed, depending on one or more such things as; ease of movement; strength of the user; and the length of the user's arms.

The embodiment illustrated includes four shafts 212. Various embodiments may have various numbers of shafts 212. Various embodiments may have shafts 212 that are removable from the second holding elements 250 enabling the cleaning cart 200 to be selectively configured to offload various numbers of blades 18. More than one holding shaft 212 may also enable blades 18 to be split up among plural shafts which may enable use of a narrower cleaning cart 200 and/or a wider cutting assembly 10.

FIG. 7 is a flow diagram illustrating a method of dissembling portions of a cutting apparatus for cleaning in accordance with various embodiments. The method 400 may include:
removing a second end support to expose a second end of a shaft, the shaft being supported at a first end thereof and non-supported at the second end, multiple blades may be supported by the shaft, each of the multiple blades may have a hole there through for being fitted onto the shaft, 402; and
removing the blades from the shaft by sliding the blades along the shaft and off the second end, 404.

In some embodiments the method 400 may include, prior to removing the second end support, removing at least one rod by pulling the rod in a direction substantially parallel to the shaft through a respective at least one hole in the second end plate. The at least one rod, prior to being removed, may have a first end coupled with a first end plate opposite the second end plate and may be adapted to provide stability to the cutting apparatus.

In some embodiments the removing the second end support may include manipulating a release lever to uncouple the second end support from a side wall. The side wall may be part of, or coupled with, a frame structure adapted to support the cutting assembly.

In some embodiments the method 400 may include: aligning a holding shaft collinearly with the shaft; coupling a second end of the holding shaft with the second end of the shaft; and further sliding the blades off of the shaft and onto the holding shaft.

In some embodiments the sliding the blades may include pulling or pushing the blades with a blade transfer element. The blade transfer element may have an end wall having a notch wide enough to fit over the shaft and narrow enough to contact a face of the blades while the blade transfer element is being pulled or pushed toward the holding shaft and away from the shaft.

FIG. 8 is a flow diagram illustrating a method in accordance with various embodiments. The method 500 may include:
aligning a holding shaft with a shaft on a cutting apparatus, 502; and
sliding one or more blades from being supported by the shaft to being supported by the holding shaft. The one or more blades may each have a hole there through for being fitted onto each of the shaft and the holding shaft, 504.

In some embodiments the holding shaft may be supported on a first end and cantilevered at the second end, and the shaft may be supported on a first end and cantilevered at the second end, and the aligning the two second ends may include coupling the holding shaft with the shaft.

In some embodiments the method 500 may include, prior to the aligning the holding shaft with a shaft on a cutting apparatus, removing a second end support to expose a second end of a shaft the shaft supported at a first end and unsupported at the second end. In some embodiments the method 500 may include manipulating a latch to provide a quick release of the second end support from a side wall of a cutting machine. In some embodiments the method 500 may include, prior to the removing the second end plate, removing a first rod from spanning from above a protrusion on each of a row of kick-out fingers by pulling the first rod longitudinally along the assembly through a first hole in a side plate. The kick out fingers may be interposed between respective multiple of the one or more blades.

In some embodiments the method 500 may include removing the kick-out fingers from between the multiple blades and placing them in a container for cleaning. In some embodiments the holding shaft may be on a cleaning cart which may include holding elements for at least one of: the rods, the container, and the end plate.

Although certain embodiments have been illustrated and described herein for purposes of description of the preferred embodiment, it will be appreciated by those of ordinary skill in the art that a wide variety of alternate and/or equivalent embodiments or implementations calculated to achieve the same purposes may be substituted for the embodiments shown and described without departing from the scope of the present invention. Those with skill in the art will readily appreciate that embodiments in accordance with the present invention may be implemented in a very wide variety of ways. This application is intended to cover any adaptations or variations of the embodiments discussed herein. Therefore, it is manifestly intended that embodiments in accordance with the present invention be limited only by the claims and the equivalents thereof.

What is claimed is:

1. A food cutting apparatus comprising:
a shaft having a first end and a second end;
multiple blades disposed on the shaft for rotation with the shaft;
a first side support coupled to the cutting apparatus for holding the shaft at the first end;
a removable second side support releasably coupled to the second end of the shaft; and
wherein the first end support is sufficiently strong to support the shaft and the multiple blades without there being support for the second end.

2. The cutting apparatus of claim 1 further comprising a plurality of spacers and kick out fingers, each being disposed between each of the respective multiple blades fitted onto the shaft, wherein the kick out fingers have a first end having a profile substantially similar to an annular outside surface of each of the spacers and adapted to engage the spacers, and a second end adapted to interface with one or more cross members adapted to restrain movement of the kick out fingers.

3. The cutting apparatus of claim 1, wherein removal of the second side support exposes the second side of the shaft to enable the blades to be removed from the shaft.

4. The cutting apparatus of claim 1 further comprising one or more cross members removably disposed between and supported at respective first and second ends by the first side support and the second side support, the cross members adapted to interface with the kick out fingers second ends to help restrain rotational movement.

5. The cutting apparatus of claim 4, further comprising guide blocks and one or more guide block cross members positioned to help restrain movement of the guide blocks.

6. The cutting apparatus of claim 1, wherein the second end of the shaft is adapted to mate with a transfer shaft to allow the blades to be slid in a linear fashion on to the transfer shaft.

7. The cutting apparatus of claim 1 further comprising:
a stabilizing cross member disposed substantially parallel with the shaft; and
one or more stabilizer plates located between the first end and the second end of the shaft and interposed between one or more of the multiple blades, the one or more stabilizer plates adapted to receive a load or force imposed on the shaft that is created by difficult to cut material and adapted to transfer the load or force to the stabilizing rod to help resist non-rotational movement of the shaft.

8. A method of dissembling a knife shaft assembly of a cutting apparatus for cleaning comprising:
removing a second end plate to expose a second end of a shaft, the shaft being supported at a first end thereof and not supported at the second end, multiple blades being supported by the shaft, each of the multiple blades having a hole there through for being fitted onto the shaft; and
removing the blades from the shaft by sliding the blades along the shaft and off the second end.

9. The method of claim 8 wherein prior to removing the end plate, removing at least one rod by pulling the rod in a direction substantially parallel to the shaft through a respective at least one hole in the second end plate.

10. The method of claim 9 wherein the at least one rod has a pulling feature which allows a user to pull the rod.

11. The method of claim 8 wherein the removing the second end plate includes manipulating a release lever to uncouple the second end plate from a side wall, the side wall being part of or coupled with a frame structure adapted to support the cutting apparatus.

12. The method of claim 8 further comprising:
aligning a holding shaft collinearly with the shaft;
coupling a second end of the holding shaft with the second end of the shaft; and
sliding the blades off of the shaft and onto the holding shaft.

13. The method of claim 12 wherein the further sliding the blades includes:
providing a blade transfer element having an end wall having a notch wide enough to fit over the shaft and narrow enough to contact a face of the blades while the blade transfer element is being pulled or pushed toward the holding shaft and away from the shaft
pulling or pushing the blades with a blade transfer element.

14. A method of disassembling a cutting shaft assembly on a cutting apparatus comprising:
aligning a holding shaft with a shaft on a cutting apparatus; and
sliding one or more blades from being supported by the shaft to being supported by the holding shaft, the one or more blades each having a hole there through for being fitted onto each of the shaft and the holding shaft.

15. The method of claim 14 wherein the holding shaft is supported on a first end and cantilevered at the second end, and the shaft is supported on a first end and cantilevered at the second end, and the aligning includes coupling the holding shaft with the shaft.

16. The method of claim 14 further comprising, prior to the aligning the holding shaft with a shaft on a cutting apparatus, removing a second end plate to expose a second end of a shaft the shaft supported at a first end and unsupported at the second end.

17. The method of claim 16 further comprising manipulating a locking latch to provide a quick release of the second end plate from a side wall of a cutting arrangement, the cutting apparatus supported by the cutting arrangement.

18. The method of claim 16 further comprising, prior to the removing the second end plate, removing a first rod from spanning from above a protrusion on each of a row of kick-out fingers by pulling the first rod longitudinally along the assembly through a first hole in a side plate, the kick out fingers being interposed between respective multiple of the one or more blades.

19. The method of claim 18 further comprising removing the kick-out fingers from between the multiple blades and placing them in a container for cleaning.

20. The method of claim 19 wherein the holding shaft is on a cleaning cart which includes holding elements for at least one of: the rods, the container, and the end plate.
